(19) United States
(12) Patent Application Publication
(10) Pub. No.: US 2004/0088280 A1
(43) Pub. Date: May 6, 2004

(54) Electronic file classification and storage system and method

(76) Inventors: Eng-Giap Koh, Penang (MY); Chee-Khuan Law, Penang (MY); Yeou-Nee Khor, Penang (MY); Pei-San Lee, Penang (MY); Shih-Hsiung Weng, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/454,007

(22) Filed: Jun. 3, 2003

(30) Foreign Application Priority Data
Nov. 1, 2002 (TW) 091132353

(51) Int. Cl. G06F 17/30

(52) U.S. Cl. 707/2

(57) ABSTRACT

A electronic file classification and storage system and method is proposed, which is designed for use to transfer a collection of files of various formats from a file source to a destination storage unit, and which is characterized by the capability of classifying these files based on their respective formats and then store these files in corresponding format-specific folders in the file management system of the destination storage unit. This feature allows the user to more easily and quickly find a file of a particular format in the file management system of the destination storage unit, and since files of the same format are stored in one specific folder, it allows the user to more efficiently and structurally manage the files in the file management system of the destination storage unit.

### BACKGROUND OF THE INVENTION

1. Field of the Invention

This invention relates to information technology, and more particularly, to an electronic file classification and storage system and method which is capable of transferring a collection of electronic files from a file source, such as a CD/DVD unit, a DSC (Digital Still Camera) unit, an MMV (MultiMedia Viewer) unit, an I-View unit, a PSV (Photo Storage Viewer) unit, a PDA (Personal Digital Assistant) unit, a PC unit (desktop or notebook), a flash memory module, and so on, based on the respective formats of this collection of files into corresponding format-specific folders in the file management system of a destination storage unit, such as PC's hard disk, rewritable CD/DVD, MMV's internal memory module, PSV's internal memory module, PDA's internal memory module, or various other kinds of rewritable memory modules.

2. Description of Related Art

Information platforms, such as PC (Personal Computer), PDA (Personal Digital Assistant), DSC (Digital Still Camera), MMV (MultiMedia Viewer), I-View devices, PSV (Photo Storage Viewer), etc., are capable of processing electronic files of various formats, such as Microsoft Word document files (*.doc), Microsoft Excel spreadsheet files (*.xls), pure text files (*.txt), MP3 files (*.mp3), graphics files such JPEG (*.jpg), TIFF (*.tif), BMP (*.bmp), GIF (*.gif) files, to name just a few.

In GUI (Graphic User Interface) based operating systems, such as Microsoft Windows operating systems, folders are used for storing files. When a user wants to open a certain file, the user needs to first locate the folder where the desired file is stored and then select the file from that folder to open the file.

In multimedia applications, users often want to transfer a collection of files of various formats from one storage place to another, i.e., from a file source such as CD/DVD, DSC, MMV, I-View, PSV, PDA, PC, flash memory module, and so on, to a destination storage unit such as a PC's hard disk, rewritable CD/DVD, and so on. Conventionally, these files are transferred in one pass to a default or a user-specified folder in the file management system of the destination storage unit. One drawback to this practice, however, is that when the transferred collection of files include various file formats, it would be apparently inconvenient for the user to manage these files efficiently in the file management system of the destination storage unit.

### SUMMARY OF THE INVENTION

It is therefore an objective of this invention to provide an electronic file classification and storage system and method which is capable of transferring a collection of files from a file source to a destination storage unit based on the classification of file formats, so that all the files of the same format can be transferred to one format-specific folder.

It is another objective of this invention to provide an electronic file classification and storage system and method which allows the user to more easily and quickly find a file of a particular format from the file management system of the destination storage unit.

It is still another objective of this invention to provide an electronic file classification and storage system and method which allows files of the same format to be stored in one folder so that the user can more efficiently and structurally manage his/her electronic files.

The electronic file classification and storage system and method according to the invention is capable of transferring a collection of files of various formats from a file source to a destination storage unit, and which is characterized by the capability of classifying these files based on their respective formats and then store these files in corresponding format-specific folders in the file management system of the destination storage unit. This feature allows the user to more easily and quickly find a file of a particular format in the file management system of the destination storage unit, and since files of the same format are stored in one specific folder, it allows the user to more efficiently and structurally manage the files in the file management system of the destination storage unit.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the electronic file classification and storage system according to the invention; and

FIG. 2 is a flow diagram showing the procedural steps of the operation of the electronic file classification and storage system and method according to the invention.

### DETAILED DESCRIPTION OF PREFERRED EMBODIMENT

A preferred embodiment of the electronic file classification and storage system and method according to the invention is disclosed in full details by way of examples in the following with reference to the accompanying drawings.

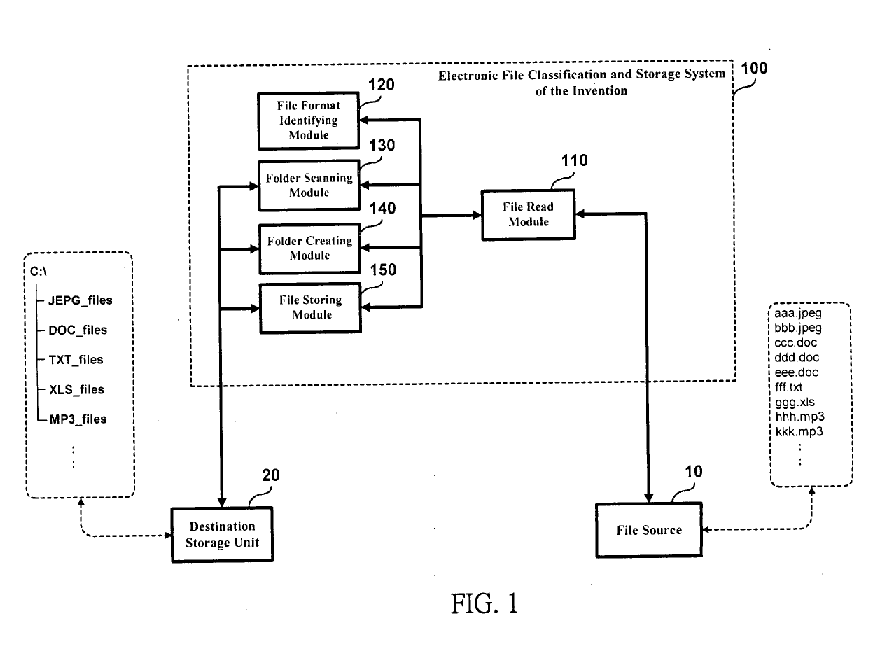

FIG. 1 is a schematic diagram showing the architecture of the electronic file classification and storage system according to the invention (as the part enclosed in the dotted box indicated by the reference numeral 100). As shown, the electronic file classification and storage system of the invention 100 is designed for use to transfer a collection of files from a file source 10, such as a CD/DVD unit, a DSC (Digital Still Camera) unit, an MMV (MultiMedia Viewer) unit, an I-View unit, a PSV (Photo Storage Viewer) unit, a PDA (Personal Digital Assistant) unit, a PC unit (desktop or notebook), an external memory module, and so on, based on the classification of the formats of these files to corresponding format-specific folders in the file management system of a destination storage unit 20, such as PC's hard disk, rewritable CD/DVD, MMV's internal memory module, PSV's internal memory module, PDA's internal memory module, or various other kinds of rewritable memory modules.

Fundamentally, the electronic file classification and storage system of the invention 100 comprises: (a) a file read module 110; (b) a file format identifying module 120; (c) a folder scanning module 130; (d) a folder creating module 140; and (e) a file storing module 150.

In practice, for example, the electronic file classification and storage system of the invention 100 can be implemented as an add-in software module installed on the computer platform where the destination storage unit 20 is installed. This allows the user to operate the electronic file classification and storage system of the invention 100 through the computer platform.

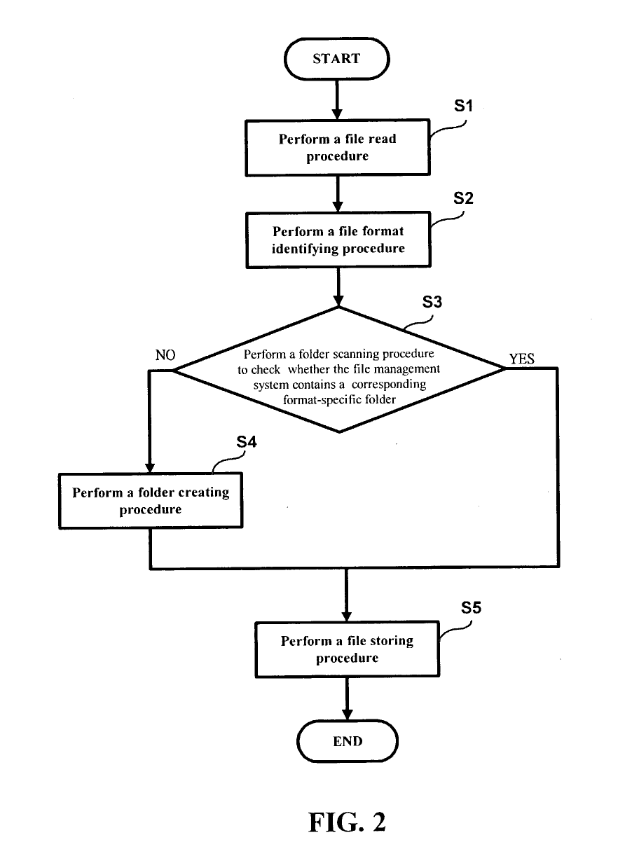

FIG. 2 is a flow diagram showing the procedural steps of the operation of the electronic file classification and storage system of the invention 100. In the following example, it is assumed that the file source 10 contains a collection of electronic files of various formats, including, for example, JPEG files (* jpg), Microsoft Word document files (*.doc), text files (*.txt), Microsoft Excel spreadsheet files (*.xis), and MP3 files (*.mp3). It is to be noted that these file formats are used here only for demonstrative purpose and not intended as limitations to the invention. In practice, the file source 10 may contain various other file formats that are commonly used in personal computing.

In application, the user needs to interface the file source 10 with the destination storage unit 20 so that files stored in the file source 10 can be transferred to the destination storage unit 20 by the electronic file classification and storage system of the invention 100. When the electronic file classification and storage system of the invention 100 is activated by the user, it performs the procedural steps shown in FIG. 2.

Referring to FIG. 2 together with FIG. 1, in the first step S1, the electronic file classification and storage system of the invention 100 performs a file read procedure, wherein the file read module 110 is activated to read each file from the file source 10 that is user-selected for transfer to the destination storage unit 20.

In the next step S2, a file format identifying procedure is performed, wherein the file format identifying module 120 is activated to identify the particular format of each of the files from the destination storage unit 20. In this example, it is assumed that the file formats include *.jpg, *.doc, *.txt, *.xis, and *.mp3.

In the next step S3, a folder scanning procedure is performed, wherein the folder scanning module 130 is activated to scan the existing folder structure in the file management system of the destination storage unit 20 to check whether the file management system already contains a format-specific folder for each file's format. If NO, the procedure goes to the step S4; otherwise, if YES, the procedure goes to the step S5.

For example, if a certain file's format is JPEG, then the folder scanning module 130 will check whether the existing folder structure of the file management system of the destination storage unit 20 contains a folder that is specifically designated for the storage of JPEG files (the name of such a folder can be named, for example, as “JPEG_files”).

In step S4, a folder creating procedure is performed, wherein the folder creating module 140 is activated to create a format-specific folder in the file management system of the destination storage unit 20. For example, if file format is JPEG, then the folder creating module 140 will create a folder named, for example, “JPEG_files”, in the file management system of the destination storage unit 20 and specifically designate this folder for the storage of files of the JPEG format. The procedure then goes to the step S5.

In step S5, a file storing procedure is performed, wherein the file storing module 150 is activated to store each file into its corresponding format-specific folder in the file management system of the destination storage unit 20.

For example, if a file's format is JPEG, then the file storing module 150 will store this file in a folder specifically designated for the storage of JPEG files, such as a folder named “JPEG_files”; if a file's format is Microsoft Word document, then the file storing module 150 will store this file in a folder specifically designated for the storage of Microsoft Word document files, such as a folder named “DOC_files”; if a file's format is text, then the file storing module 150 will store this file in a folder specifically designated for the storage of text files, such as a folder named “TXT_files”; if a file's format is Microsoft Excel spreadsheet, then the file storing module 150 will store this file in a folder specifically designated for the storage of Microsoft Excel spreadsheet files, such as a folder named “XLS_files”; if a file's format is MP3, then the file storing module 150 will store this file in a folder specifically designated for the storage of MP3 files, such as a folder named “MP3_files”; and so forth. This allows a collection of files from the file source 10 to be classified based on their respective formats and then stored in corresponding format-specific folders in the file management system of the destination storage unit 20.

It is to be noted that the example of folder names used above are only intended for demonstrative purpose and not intended as limitations to the invention. In practice, the names of format-specific folders can be arbitrarily specified by the user. Fundamentally, each format-specific folder in the file management system of the destination storage unit 20 is only used for holding files of the specified format.

In conclusion, the invention provides an electronic file classification and storage system and method, which is capable of transferring a collection of files of various formats from a file source to a destination storage unit, and which is characterized by the capability of classifying these files based on their respective formats and then store these files in corresponding format-specific folders in the file management system of the destination storage unit. This feature allows the user to more easily and quickly find a file of a particular format in the file management system of the destination storage unit, and since files of the same format are stored in one specific folder, it allows the user to more efficiently and structurally manage the files in the file management system of the destination storage unit.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An electronic file classification and storage method for transferring at least one electronic file from a file source based on the classification of file formats into a format-specific folder in a file management system of a destination storage unit;
the electronic file classification and storage method comprising the steps of:
performing a file read procedure to read the file from the file source which is user-selected for transfer to the destination storage unit;
performing a file format identifying procedure to identify the file's format;
performing a folder scanning procedure to scan the file management system of the destination storage unit to check whether the file management system contains a format-specific folder corresponding to the file's format;
if NO, performing a folder creating procedure to create a format-specific folder corresponding to the file's format, and then performing a file storing procedure;
otherwise, if YES, performing a file storing procedure;
wherein in the file storing procedure, the file is stored based on the file's format into the corresponding format-specific folder in the file management system of the destination storage unit.

2. The electronic file classification and storage method of claim 1, wherein the file source is a DSC unit.

3. The electronic file classification and storage method of claim 1, wherein the file source is an MMV unit.

4. The electronic file classification and storage method of claim 1, wherein the file source is an I-View unit.

5. The electronic file classification and storage method of claim 1, wherein the file source is a PSV unit.

6. The electronic file classification and storage method of claim 1, wherein the file source is a PDA unit.

7. The electronic file classification and storage method of claim 1, wherein the file source is a CD/DVD disc.

8. The electronic file classification and storage method of claim 1, wherein the file source is a flash memory module.

9. The electronic file classification and storage method of claim 1, wherein the file source is a PC platform. 10. The electronic file classification and storage method of claim 1, wherein the destination storage unit is a PC's hard disk.

11. The electronic file classification and storage method of claim 1, wherein the destination storage unit is a rewritable CD/DVD disc.

12. The electronic file classification and storage method of claim 1, wherein the destination storage unit is an MMV unit's internal memory module.

13. The electronic file classification and storage method of claim 1, wherein the destination storage unit is an I-View unit's internal memory module

14. The electronic file classification and storage method of claim 1, wherein the destination storage unit is a PSV unit's internal memory module.

15. The electronic file classification and storage method of claim 1, wherein the destination storage unit is a PDA unit's internal memory module.

16. The electronic file classification and storage method of claim 1, wherein the destination storage unit is a rewritable memory module.

17. An electronic file classification and storage system for transferring at least one electronic file from a file source based on the classification of file formats into a format-specific folder in a file management system of a destination storage unit;
the electronic file classification and storage system comprising:
a file read module, which is capable of reading the file from the file source which is user-selected for transfer to the destination storage unit;
a file format identifying module, which is capable of identifying the format of the file from the file source;
a folder scanning module, which is capable of scanning the folder structure of the file management system of the destination storage unit to check whether the file management system contains a format-specific folder corresponding to the file's format;
a folder creating module, which is capable of creating a format-specific folder corresponding to the file's in the event that the folder scanning module checks that file management system contains no format-specific folder corresponding to the file's format; and
a file storing module, which is capable of storing the file based on the classification of the file's format into the corresponding format-specific folder in the file management system of the destination storage unit.

18. The electronic file classification and storage system of claim 17, wherein the file source is selected from the group comprising: DSC unit, MMV unit, I-View unit, PSV unit, PDA unit, CD/DVD disc, flash memory module, and PC platform.

19. The electronic file classification and storage system of claim 17, wherein the destination storage unit is selected from the group consisting of: rewritable CD/DVD, memory module in MMV, memory module in I-View, memory module in PSV, memory module in PDA, and flash memory module.
